(19) United States
(12) Patent Application Publication
(10) Pub. No.: US 2010/0027920 A1
(43) Pub. Date: Feb. 4, 2010

(54) Fire barrier housing/insert

(76) Inventors: Bruce Raidl, Schriever, LA (US); John O. Williams, Robbinsdale, MN (US)

Correspondence Address: Thomas N. Phung;JACOBSON AND JOHNSON, LLC, Suite 285, One West Water Street, St. Paul, MN, 55107-2080, US

(21) Appl. No.: 12/462,390

(22) Filed: Aug. 3, 2009

Related U.S. Application Data
(60) Provisional application No. 61/137,887, filed on Aug. 4, 2008.

(51) Int. Cl. B65D 33/16; B32B 5/26; B32B 1/02

(52) U.S. Cl. 383/42; 428/221; 428/34.1; 428/36.1; 428/35.6

(57) ABSTRACT

A fire resistant and heat insulating flexible portable container comprising a housing having an interior compartment therein for receiving articles to be protected from heat and fire therein, a closeable aperture for allowing a user access to the interior compartment of said housing, a first layer of non-combustible fire resistant and heat insulating fabric encasing the interior compartment of said housing, a second layer of non-combustible fire resistant and heat insulating fabric covering said first layer of fire resistant and heat insulating fabric and a non-combustible heat insulating mat or pad sandwiched between said first layer of fire resistant and heat insulating fabric and said second layer of fire resistant and heat insulating fabric.

### CROSS REFERENCE TO RELATED APPLICATIONS

This application claims priority to currently pending U.S. Provisional Application Ser. No. 61/137,887; filed on Aug. 4, 2008; titled FIRE BARRIER HOUSING/INSERT.

### FIELD OF THE INVENTION

This invention relates generally to fire resistant and heat insulating devices and more specifically to a fire resistant and heat insulating flexible housing for protecting valuable and personal items from heat and fire.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Fire resistant and heat insulating housing for storing valuable and personal items are know in the art. For example fire resistant and heat insulating safes and similar housings are known in the art and work for their intended purpose of protecting valuable and personal items from exposure to fire and heat. However, known fire resistant and heat insulating safes are made generally from metal or other heavy weighed materials and thus are not very portable as they tend to be heavy and cumbersome to move from one location to the next.

In order to reduce the weight of the aforementioned housings while still maintaining the fire resistance and heat resistance properties of the housing, various types of lightweight fire resistant and heat insulating compositions have been experimented with. An example of a type of known fire resistant and heat insulating composition are those that contain asbestos. Although asbestos-based housings or asbestos-containing housings are relatively light weight and are considered effective in providing fire resistance and heat resistance properties, it has been found that exposure to asbestos can lead to adverse health risks thus the current use of asbestos is limited. It is also noted that other types of known fire resistant and heat insulating composition that are non-asbestos based currently exist. However, the non-asbestos based fire resistant and heat insulating composition generally are not adequate for higher temperature applications.

### SUMMARY OF THE INVENTION

The present invention comprises a fire resistant and heat insulating flexible portable container and a fire resistant and heat insulating tarp. The fire resistant and heat insulating flexible portable container includes a housing having an interior compartment therein for receiving articles to be protected from heat, fire, and water therein. Located on a surface of the housing is a closeable aperture for allowing a user access to the interior compartment of the housing. The housing includes a first layer of non-combustible fire resistant and heat insulating fabric comprising silica or fiberglass-based fabric encasing the interior compartment of said housing and a second layer of non-combustible fire resistant and heat insulating fabric comprising silica or fiberglass-based fabric covering said first layer of fire resistant and heat insulating fabric. The first and second layers of fire resistant and heat insulating fabric also have the properties of being water resistant. The housing further includes a non-combustible heat insulating mat or pad comprising a ceramic or silica fiber-based mat sandwiched between said first layer of fire resistant and heat insulating fabric and said second layer of fire resistant and heat insulating fabric.

The fire resistant and heat insulating flexible portable container may also include a fire and water resistant laminated material comprising aluminum foil, neoprene, silicone rubber, PFFE, or Teflon applied to a surface of said second layer of fire resistant and heat insulating fabric; a decorative fire and water resistant skin surrounding said second layer of fire resistant and heat insulating fabric, a cover attached to the housing and extending over the aperture for controlling user access to said aperture; and a fastening member for maintaining said housing in a closed condition. The fire resistant and heat insulating flexible portable container may also include fastening member comprising fire resistant Velcro-based pads.

The fire and water resistant and heat insulating tarp includes a first layer of non-combustible fire resistant and heat insulating fabric comprising a silica or fiberglass-based fabric and a second layer of non-combustible fire resistant and heat insulating fabric comprising a silica or fiberglass-based fabric. Sandwiched between the first layer of fire resistant and heat insulating fabric and the second layer of fire resistant and heat insulating fabric is a non-combustible heat insulating mat or pad comprising a ceramic or silica fiber-based mat. The fire and water resistant and heat insulating tarp includes a fire resistant laminated material comprising aluminum foil, neoprene, silicone rubber, PTFE, or Teflon applied to a surface of the first layer of fire resistant and heat insulating fabric.

### BRIEF DESCRIPTION OF THE DRAWINGS

FIG. 1 is a perspective view of a fire resistant and heat insulating flexible horizontal case shown in an open condition and supporting a photo album therein;

FIG. 2 is a cross-sectional view of horizontal case of FIG. 1 taken along the lines A-A;

FIG. 3 a perspective view of a fire resistant and heat insulating flexible vertical case of shown in an open condition and supporting a laptop therein;

FIG. 4 a perspective view of a fire resistant and heat insulating tarp;

FIG. 5 a partial cross-sectional view of the fire resistant and heat insulating tarp of FIG. 4;

FIG. 6 is a perspective view showing a fire resistant and heat insulating flexible housing comprising a small duffle or gym bag;

FIG. 7 is a perspective view showing a fire resistant and heat insulating flexible housing comprising a box housing or insert;

FIG. 8 is a perspective view showing a fire resistant and heat insulating flexible housing comprising a large duffle or army bag;

FIG. 9 is a perspective view showing a fire resistant and heat-insulating flexible housing a housing or insert pouch;

FIG. 10 is a perspective view showing a fire resistant and heat insulating flexible housing comprising a back pack insert; and

FIG. 11 is a perspective view showing a fire resistant and heat insulating flexible housing comprising a large picture pouch.

### DESCRIPTION OF THE PREFERRED EMBODIMENT

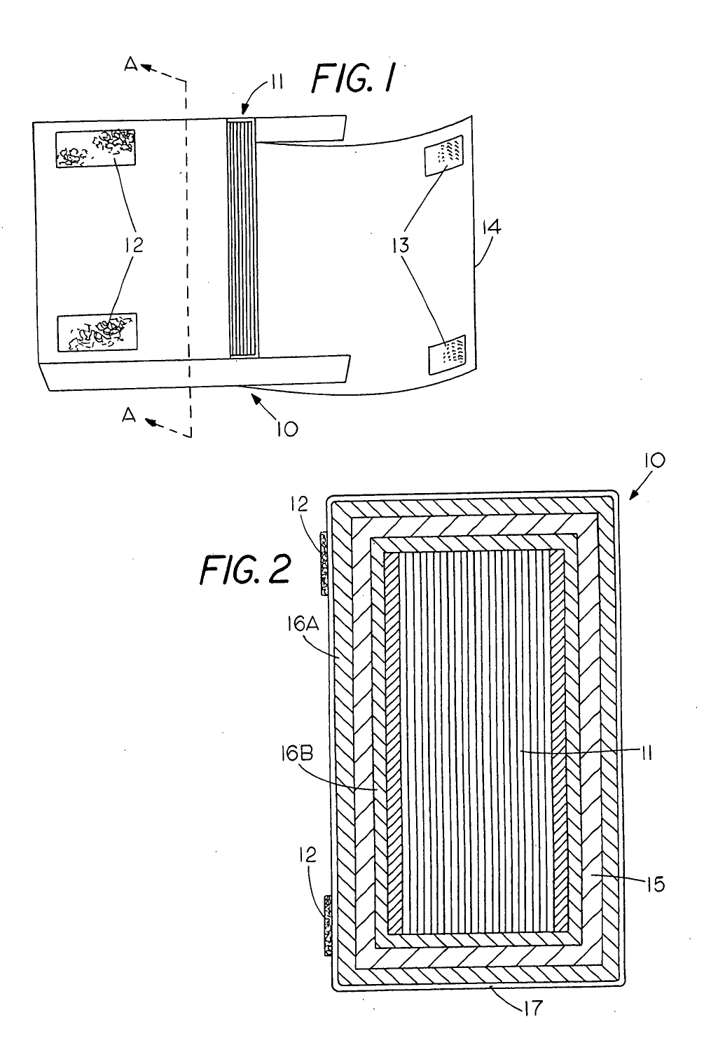

Referring to FIGS. 1 and 2, FIG. 1 is a perspective view showing an embodiment of a non-combustible fire resistant and heat insulating flexible housing comprising a horizontal case 10 for protecting valuable and personal items from extreme heat, fire, and water. The terms valuable and personal items may encompass but is not limited to paper, photos, jewelry, money, valuables, boxes, files, guns, computers, laptops, pictures, paintings, film, video, tapes, medical x-rays, sports memorabilia. In the embodiment of FIG. 1, horizontal case 10 is shown in an open condition supporting a photo album II therein. Horizontal case 10 includes fastening members comprising a set of fire resistant Velcro soft pads 12 located on an exterior surface of horizontal case 10 for attaching engagement with a set of corresponding fire resistant Velcro hook pads 13 located on a surface of a cover 14 of the vertical horizontal 10. The engagement of the fire resistant Velcro soft pads 12 to the fire resistant Velcro hook pads 13 functions to maintain horizontal case 10 in a closed condition to secure photo album 11 or anything else supported within horizontal case 10 therein. Although the embodiment of FIG. 1 show the fastening members as comprising a set of fire resistant Velcro-based pads, alternative types of fastening members or fastening means may be used including but not limited to buckle-based members, strap-based members, clamp-based members, zippers, and pin-based members.

FIG. 2 is a cross-sectional view of horizontal case 10 taken along the lines A-A showing the general components forming horizontal case 10. More specifically, horizontal case 10 generally comprises three main components, namely a non-combustible heat insulating mat or pad 15 that is enclosed between an inner layer of non-combustible fire resistant and heat insulating fabric 16B and an outer layer of non-combustible fire resistant and heat insulating fabric 16A. In general regards to the three main components of the horizontal case 10, the three main components of the horizontal case 10 may be sewn, bonded, glued, laminated to form the horizontal case 10. The three main components may also be sewn, bonded, glued, laminated to form housing/inserts having alternative shapes and design. If sewn, typical threads that are used either on the interior, exterior, or both may include but are not limited to fiberglass-based threads, a combination fiberglass and steel based thread, a combination of polyester and stainless steel-based thread, and a Kevlar-Nomex® brand-based thread.

In regards to non-combustible heat-insulating mat 15, non-combustible heat-insulating mat 15 may be composed of various types of materials that have heat insulating and fire retardant properties, that is non-combustible heat-insulating mat 15 is capable of withstanding direct exposure to flames and high temperature. Examples of suitable materials include but is not limited to ceramic or silica fiber-based mats or insulation material that generally range from ¼ inch to 12 inches in thicknesses. The individual fibers of the ceramic or silica fiber-based mats or insulation material visually are similar to that of cotton fibers. In one example of an embodiment the ceramic or silica fibers may be 2-4 micrometers in size while having a weight in the area of 4 pounds per square foot, and are usually in string form and loomed or needled together. It is noted that other embodiments may comprise the ceramic or silica fibers having a weight of more than or less than 4 pounds per square foot.

In regards to the non-combustible fire resistant and heat insulating fabric 16A and 16B, non-combustible fire resistant and heat insulating fabric 16A and 16B may be composed of various types of materials that have heat insulating and fire retardant properties including but not limited to silica and fiberglass-based fabrics. Non-combustible fire resistant and heat insulating fabric 16A and 16B each may comprise of the same material or alternatively different materials. A feature of the present invention is that non-combustible fire resistant and heat insulating fabric 16A and 16B are also capable of withstanding direct exposure to flames and high temperature. If silica or fiberglass fabrics are used the silica or fiberglass fabric typically ranges from 12 oz. to 36 oz. per square yard. It is noted that fabrics 16A and 16B not only functions as a fire retardant and heat insulator but also to hold heat insulating mat or pad 15 together. The silica or fiberglass fabrics may be used alone or in combination with additional laminated materials that are applied to the surfaces of the silica or fiberglass fabrics. Suitable laminated materials include but are not limited to aluminum foil, neoprene, silicone rubber, PTFE, Teflon, etc . . . depending on the intended use of the eventual product.

As shown in the embodiment of FIG. 2, for a more decorative look the outer layer of non-combustible fire resistant and heat insulating fabric 16A may alternatively be covered with a non-combustible decorative fire and water resistant skin 17. Examples of suitable materials for skin 17 include but is not limited to leather, suede, vinyl, nylon, cottons, polyesters, metallics, which may be sewn, bonded, glued, laminated to the outer layer of fire resistant and heat insulating fabric 16A of horizontal case 10. In order for the decorative fire and water resistant skin 17 to meet various fire ratings such as the ASTM E-84 Class A or 1, NFPA 701, FAA25.853 Aircraft, and UL 723, UBC 42-1, the decorative fire and water resistant skin 17 may be treated with various types of fire resistant chemicals such as the fire resistant chemicals manufactured and sold by American Fire Coatings, Inc. of Broussard, La. The fire resistant chemicals may be applied to the decorative fire and water resistant skin 17 by various methods including spraying, dipping, brushing, rolling depending on the material used for the decorative fire and water resistant skin 17. A feature of the treated decorative fire and water resistant skin 17 is that when exposed to fire, the exposed regions of the decorative fire and water resistant skin 17 may blacken but will not ignite.

A feature of the present invention is that the combinations of the non-combustible heat insulating mat or pad 14, the non-combustible fire resistant and heat insulating fabrics 16A and 16B, and the laminated material(s) or treated decorative fire and water resistant skin 17, which are sewn, bonded, glued, or laminated together into a variety of configurations results in a product such as a compartment, pouch, insert, sleeve, bag, or purse, that is capable of withstanding a continuous flame temperature range of 1000 degrees Fahrenheit to as high as 2300 degrees Fahrenheit while having a melting point temperature up to 3000 degrees Fahrenheit, depending on the design of the housing/insert.

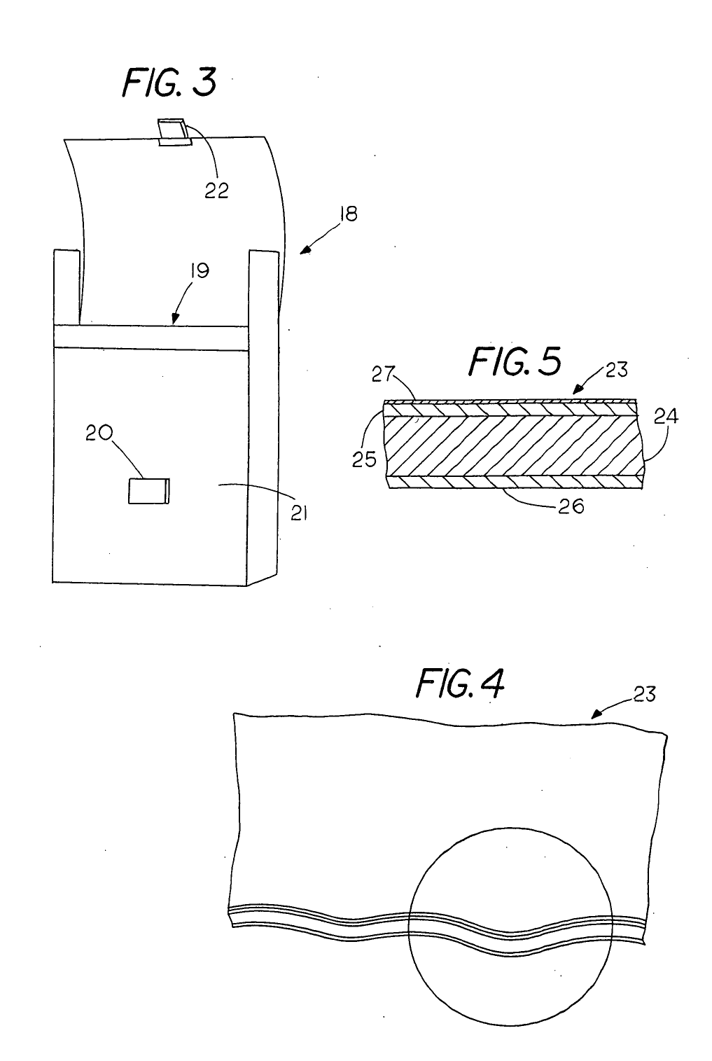

FIG. 3 is a perspective view showing an embodiment of a fire resistant and heat insulating flexible housing of the present invention comprising a vertical case 18 in an open condition supporting a laptop 19 therein. Vertical case 18 comprises similar components to the horizontal case 10 of FIGS. 1 and 2. However, instead of having fastening members comprising fire resistant Velcro-based pads 12 and 13, the fastening member for vertical case 18 comprises a latch housing 20 located on an exterior surface 21 of vertical case 18 for receiving a latch 22 located on a cover 23 of the vertical case 18.

In general regards to the fire resistant and heat insulating flexible housing of the present invention since the housing is intended to support and protect a variety of valuable and personal items such as paper, photos, jewelry, money, valuables, boxes, files, guns, computers, laptops, pictures, paintings, the compartments of the housing may vary in sizes. For example, it is noted that the compartments for the flexible housing may range in size from under 1 sq. ft. to as large as 10,000 sq. ft. depending on the particular item requiring fire and heat protection.

Referring to FIGS. 4 and 5, FIG. 4 shows a perspective view of a fire resistant and heat insulating tarp 23 of the present invention for covering and protecting larger articles such as but not limited to automobiles and home furniture from extreme heat and fire. FIG. 5 shows a partial cross-sectional view of the fire resistant and heat insulating tarp 23 of FIG. 4. Fire resistant and heat insulating tarp 23 generally comprises similar components to the horizontal case 10 and vertical case 18 of FIGS. 1, 2, and 3, namely a non-combustible heating insulating mat or pad 24 sandwiched between a first non-combustible silica or fiberglass fabric 25 and a second non-combustible silica or fiberglass fabric 26. First silica or fiberglass fabric 25 is also shown including an optional fire retardant laminated material 27 that in the present embodiment is applied to the surface of first silica or fiberglass fabric 25. As noted above, laminated material 27 may comprise but is not limited to aluminum foil, neoprene, silicone rubber, PTFE, Teflon, depending on the intended use of the eventual product.

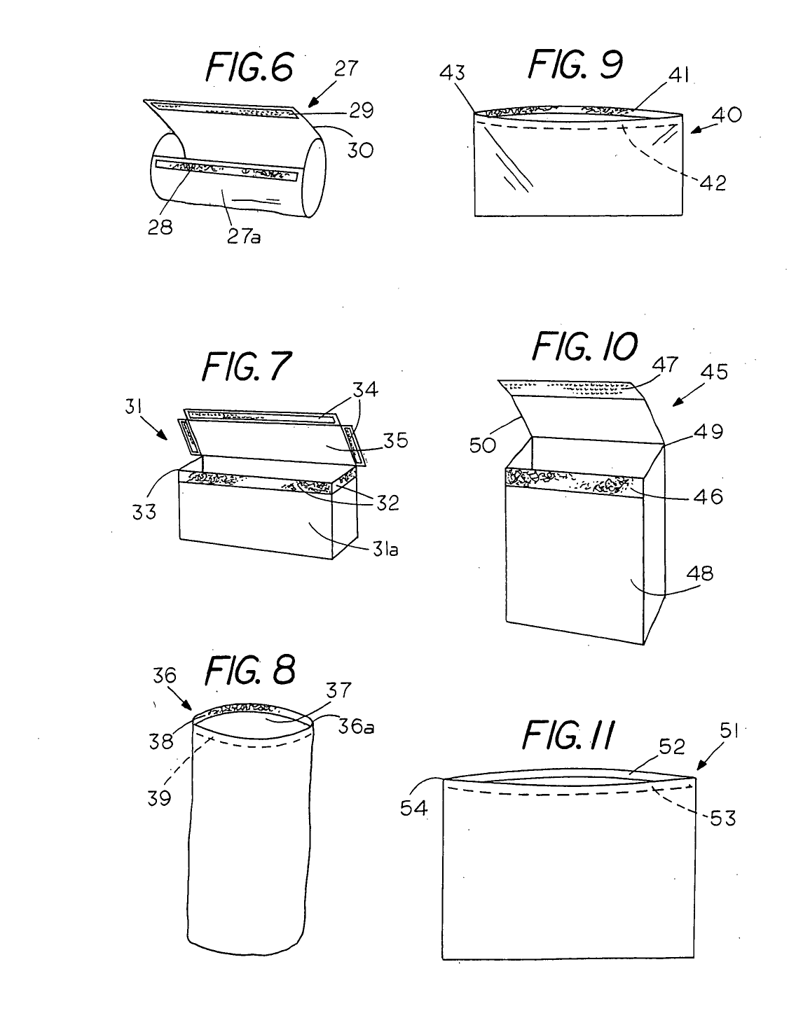

FIG. 6 is a perspective view showing an alternative embodiment of a fire resistant and heat insulating flexible housing for protecting valuable and personal items from extreme heat and fires comprising a small duffle or gym bag 27. Although not shown, duffle or gym bag 27 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. The duffle or gym bag 27 includes fastening members comprising at least one fire resistant Velcro soft pad 28 located on an exterior surface 27a of the duffle or gym bag 27 for attaching engagement with at least one corresponding fire resistant Velcro hook pad 29 located on a cover 30 of the duffle or gym bag. The engagement of the fire resistant Velcro soft pads 28 to the fire resistant Velcro hook pads 29 functions to maintain duffle or gym bag 27 in a closed condition to secure and maintain items supported within duffle or gym bag 27 therein.

FIG. 7 is a perspective view showing an alternative embodiment of a fire resistant and heat insulating flexible housing for protecting valuable and personal items from fires comprising box housing or insert 31. Although not shown, box housing or insert 31 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. In the embodiment of FIG. 7, the box housing or insert 31 includes fastening members comprising at least one fire resistant Velcro soft pad 32 located on an exterior surface 31 a of box housing or insert 31 proximal a closeable aperture or open end 33 of box housing or insert 31 for attaching engagement with at least one corresponding fire resistant Velcro hook pad 34 located on a cover 35 of box housing or insert 31.

FIG. 8 is a perspective view showing an alternative embodiment of a fire resistant and heat insulating flexible housing for protecting valuable and personal items from fires comprising a large duffle or army bag 36. Although not shown, duffle or army bag 36 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. In the embodiment of FIG. 8, large duffle or army bag 36 is shown including fastening members comprising at least one fire resistant Velcro soft pad 38 located on an interior surface 37 of the large duffle or army bag 36 proximal a closeable aperture or open end 36a of the large duffle or army bag 36 for attaching engagement with at least one corresponding fire resistant Velcro hook pad 39 located on a corresponding interior surface of the large duffle or army bag 36. Although the embodiment of FIG. 8 show the fastening members as comprising a set of fire resistant Velcro-based pads 38 and 39, alternative types of fastening members or fastening means may be used including but not limited to buckle-based members, strap-based members, clamp-based members, pin-based members, and draw cord system.

FIG. 9 is a perspective view showing an alternative embodiment of a fire resistant and heat insulating flexible housing for protecting valuable and personal items from fires comprising a pouch housing or insert 40. Pouch housing or insert 40 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. Pouch housing or insert 40 includes fastening members comprising at least one fire resistant Velcro soft pad 41 located on an interior surface of the pouch housing or insert 40 proximal a closeable aperture or open end 43 of the pouch housing or insert 40 for attaching engagement with at least one corresponding fire resistant Velcro hook pad 42 located on a corresponding interior surface of pouch housing or insert 40. It is noted that instead of fire resistant Velcro-based pad, alternative types of fastening members or fastening means may also be used pouch housing or insert 40 including but not limited to metal bands.

FIG. 10 is a perspective view showing an alternative embodiment of afire resistant and heat insulating flexible housing for protecting valuable and personal items from fires comprising a back pack insert 45. Back pack insert 45 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. The back pack insert 45 includes fastening members comprising at least one fire resistant Velcro soft pad 46 located on an exterior surface 48 of the back pack insert 45 proximal a closeable aperture or open end 49 of the back pack insert 45 for attaching engagement with at least one corresponding fire resistant Velcro hook pad 47 located on a cover 50 of the back pack insert 45.

FIG. 11 is a perspective view showing an alternative embodiment of a fire resistant and heat insulating flexible housing for protecting valuable and personal items from fires comprising a large picture pouch 51. Picture pouch 51 generally comprises similar components to the fire resistant and heat insulating tarp 23 of FIGS. 4 and 5, namely a non-combustible heating insulating mat or pad sandwiched between a first non-combustible silica or fiberglass fabric and a second non-combustible silica or fiberglass fabric. The large picture pouch 51 includes fastening members comprising at least one metal band 52 located on an interior surface of the large picture pouch 51 proximal a closeable aperture or open end 54 of the large picture pouch 51 for attaching engagement with at least one corresponding metal band 53 located on a corresponding interior surface of large picture pouch 51. In an alternative embodiment, the large picture pouch 51 may include fastening members comprising at least one fire resistant Velcro soft pad located on an interior surface of the large picture pouch 5 1 proximal the open end 54 of the large picture pouch 51 for attaching engagement with at least one corresponding fire resistant Velcro hook pad located on the corresponding interior surface of large picture pouch 51.

I claim:

1. A fire resistant and heat insulating flexible portable container comprising:
a housing having an interior compartment therein for receiving articles to be protected from heat and fire therein;
a closeable aperture for allowing a user access to the interior compartment of said housing;
a first layer of non-combustible fire resistant and beat insulating fabric encasing the interior compartment of said housing;
a second layer of non-combustible fire resistant and heat insulating fabric covering said first layer of fire resistant and heat insulating fabric; and
a non-combustible heat insulating mat or pad sandwiched between said first layer of fire resistant and heat insulating fabric and said second layer of fire resistant and heat insulating fabric.

2. The flexible portable container of claim 1 including a fire and water resistant laminated material comprising aluminum foil, neoprene, silicone rubber, PTFE, or Teflon applied to a surface of said second layer of fire resistant and heat insulating fabric.

3. The flexible portable container of claim 1 including a decorative fire and water resistant skin surrounding said second layer of fire resistant and heat insulating fabric.

4. The flexible portable container of claim 1 wherein said housing includes a cover attached to the housing and extending over the aperture for controlling user access to said aperture.

5. The flexible portable container of claim 1 wherein said housing includes a fastening member for maintaining said housing in a closed condition.

5. The flexible portable container of claim 1 wherein said housing includes a fastening member for closing said aperture of said housing.

6. The flexible portable container of claim 5 wherein said fastening member comprises fire resistant Velcro-based pads.

7. The flexible portable container of claim 5 wherein said fastening member comprises a latching system.

8. The flexible portable container of claim 1 wherein said fire resistant and heat insulating mat or pad comprises a ceramic or silica fiber based mats or insulation material.

9. The flexible portable container of claim 1 wherein said first layer of non-combustible fire resistant and heat insulating fabric and said second layer of non-combustible fire resistant and heat insulating fabric each comprises a silica or fiberglass-based fabric.

10. The flexible portable container of claim 3 wherein said decorative fire and water resistant skin comprises fire retardant treated leather, suede, vinyl, nylon, cottons, polyesters, or metallic.

11. The flexible portable container of claim 1 wherein said first layer of fire resistant and heat insulating fabric and said second layer of fire resistant and heat insulating fabric comprises can withstanding a continuous flame temperature range of 1000 degrees Fahrenheit.

12. The flexible portable container of claim 1 wherein said first layer of fire resistant and heat insulating fabric and said second layer of fire resistant and heat insulating fabric comprises different material.

13. A fire resistant and heat insulating flexible portable container comprising:
a housing having an interior compartment therein for receiving articles to be protected from heat and fire therein;
a closeable aperture for allowing a user access to the interior compartment of said housing;
a fastening member for opening and closing said aperture of said housing.
a first layer of non-combustible fire resistant and heat insulating fabric comprising a silica or fiberglass-based fabric encasing the interior compartment of said housing;
a second layer of non-combustible fire resistant and heat insulating fabric comprising a silica or fiberglass-based fabric covering said first layer of fire resistant and heat insulating fabric;
a non-combustible heat insulating mat or pad comprising a ceramic or silica fiber-based mat sandwiched between said first layer of fire resistant and heat insulating fabric and said second layer of fire resistant and heat insulating fabric; and
a fire resistant laminated material comprising aluminum foil, neoprene, silicone rubber, PTFE, or Teflon applied to a surface of said second layer of fire resistant and heat insulating fabric.

14. The flexible portable container of claim 13 including a decorative fire and water resistant skin surrounding said second layer of fire resistant and heat insulating fabric.

15. The flexible portable container of claim 13 wherein said housing includes a cover for controlling user access to said aperture.

16. The flexible portable container of claim 13 wherein said fastening member comprises fire resistant Velcro-based pads.

17. The flexible portable container of claim 13 wherein said fastening member comprises a latching system.

18. A fire resistant and heat insulating tarp comprising:
a first layer of non-combustible fire resistant and heat insulating fabric;
a second layer of non-combustible fire resistant and heat insulating fabric;
a non-combustible fire resistant and heat insulating mat or pad sandwiched between said first layer of fire resistant and heat insulating fabric and said second layer of fire resistant and heat insulating fabric; and
a fire resistant laminated material comprising aluminum foil, neoprene, silicone rubber, PTFE, or Teflon applied to a surface of said first layer of fire resistant and heat insulating fabric.

19. The flexible portable container of claim 18 wherein said fire resistant and heat insulating mat or pad comprises a ceramic or silica fiber based mats or insulation material.

20. The flexible portable container of claim 18 wherein said first layer of fire resistant and heat insulating fabric and said second layer of fire resistant and heat insulating fabric each comprises a silica or fiberglass-based fabric.
